(19) United States
(12) Patent Application Publication
(10) Pub. No.: US 2004/0199768 A1
(43) Pub. Date: Oct. 7, 2004

(54) System and method for enabling enterprise application security

(76) Inventor: Robert A. Nail, Sachse, TX (US)

Correspondence Address: Michael G. Cameron, Jackson Walker LLP., Suite 600, 2435 North Central Expressway, Richardson, TX, 75080, US

(21) Appl. No.: 10/626,245

(22) Filed: Jul. 24, 2003

Related U.S. Application Data
(60) Provisional application No. 60/460,520, filed on Apr. 4, 2003.

(51) Int. Cl. H04L 9/00

(52) U.S. Cl. 713/169

(57) ABSTRACT

The present invention relates to a method and a system for establishing secure and trusted communications over computer networks TREM (301) resides on a computer hardware server inside the enterprise data center. The ICS module (302) of the present invention resides on a participant PC. TREM (301) serves as the control center and inspects and validates identification card information, validates virtual security officer(s) (303) signatures, determines if the request being received is from an authenticated user, determines placement of non-trusted data received based on rules and policies, encrypts/decrypts transmission data, keeps audits of all activities performed in the system, and notifies other authorities for alternative processing to handle non-trusted data. The virtual security officer(s) (303) module of TREM (301) replaces cumbersome certificate authorities. The ICS module (302) performs certain functions including participant self-registration, creating private signing key and verification, performing authentication of the participant, generating MAC for data integrity, placing electronic signatures, and encrypting/decrypting transmission data.

### CROSS REFERENCE TO RELATED APPLICATION

This application is related to U.S. provisional patent application No. 60/460,520, filed Apr. 4, 2003, entitled “METHOD AND APPARATUS FOR PROVIDING TRUSTED COLLABORATION IN A VIRTUAL OPEN MARKET”, the entire contents of which are incorporated herein by this reference. The Applicants hereby claim the benefits of this earlier pending provisional application under 35 U.S.C. Section 119(e).

### TECHNICAL FIELD

The present invention relates to a method and a system for establishing secure and trusted communications over computer and data networks. More specifically, the present invention is directed to providing a methodology and system that enables a protocol independent means to authenticate the true identity of the participants in data exchange as well as computer and data access within a distributed data processing and/or computing environment. As used herein, “participant(s)” refer to user(s), individual(s), service(s) or process(es) that must or desire to work together over a computing network; a “requester” refers to a participant who desires to send information or obtain access through a trusted manager (as described herein); “enterprise” refers to a company, implementer, facilitator, or administrator charged with establishing and administering a secure computing and communications network; “collaboration” refers to the ability of participants to work together; “true identity” refers to the ability of the enterprise and/or participant to factually establish the identity of the other enterprise(s) and/or participant(s); “trusted collaboration” is the ability to trust the participants who are working together; “trusted registration” refers to the process of participant verification; “ICS” refers to the intelligent client services software module of the present invention and “TREM” refers to the Trusted Remote Engine Manager software module of the present invention which comprises servers and services that perform the identification, registration, generation of identification card, inspection and validation services, as well as rules and policies enforcement and security auditing services.

### BACKGROUND OF THE INVENTION

Reliable two-way identification, authentication and authorization of participants and services is essential for achieving security in a distributed computing environment. Identification refers to the method in which a participant is referenced. Authentication refers to the method in which a participant may prove its, his or her identity. Authorization refers to the method for determining what a given participant may do. Authentication and authorization are distinct processes, the former related to proving an identity and the latter related to the properties of an identity.

Two-way authentication schemes generally involve hand-shaking techniques so that each party may verify that it, he or she is in communication with the desired party regardless of each party's location or the types of devices in use. When a first participant communicates with a second participant, there is desired a mechanism by which the second participant can authenticate the first participant's identity and vice versa.

Identification, authentication and authorization are critical to protecting access to sensitive data which is exchanged over a computing network, regardless of application. Protecting access to sensitive data, such as credit card data and personal information, has become a paramount concern to enterprises and participants. This is even more important with respect to information exchanged over a virtual open market. A virtual open market can be an e-mail exchange, world wide web (“WWW”) access or almost any type of information exchange. The virtual open market is distinguished from the virtual private network (“VPN”). The VPN has a lesser risk of vulnerability than the open network, yet, nevertheless, has security issues. Disadvantageously, most data exchanges are not able to trust the data that is received or to trust the identity of the participants who have access to information.

Notwithstanding the security issues, there are advantages to using an open system for communications. To illustrate, FIGS. 1 and 2 depict the components and objects of an open system, the conventional telephone system and the operation of the conventional telephone system in process. FIG. 2 depicts a user issuing a request for a call. The telephone company determines where the call or request is to be sent and dispatches the call to the appropriate call center. The call center then forwards the request to the end client. Notice that each telephone can be from a different manufacturer. An old model telephone may not have special options for caller ID and similar features, however, it will still be possible for the old model telephone to receive the call. Even if a telephone is taken away from the system or replaced with a telephone that does not contain certain options, the system as a whole will continue to operate. The information will be delivered based on the protocol standards being used, not the end clients, here the telephones. The benefit of an open solution is that participants and enterprises can make use of many different client types and are not restricted to one single type. The standard protocol used for collaboration primarily is TCP/IP. Conventional collaboration products establish trust at a client application level forcing enterprises to require the same look and feel of a single client for trusted data exchange or access. Analogizing to FIGS. 1 and 2, if this methodology had been used in the telephone example, then participants with cell phones would only be able to communicate with those having identical cell phones.

Furthermore, using the open telephone system, a caller may use a telephone to call whomever he desires. However, if a receiver is unable to identify the caller then the call will either be ignored or the call will be received with caution. Likewise, the users of two business applications may desire to send and receive data using an agreed protocol of exchange. These include, for example, participants performing a data exchange such as e-mail, a participant performing file transfers to or from a system, or a participant desiring to obtain access to a system. All of these transactions require a collaborative effort at each end point between participants and enterprise systems. In order to provide a secure computing environment, true identity of the participants must be established in order to permit trusted collaboration. Analogizing to the conventional telephone, an individual who desires telephone service at their residence must provide true identification to the telephone company before the true identity of the individual can be authenticated in later telephone communications. The participants of the present invention have to perform a similar task by providing true identification information to the registration server of TREM. This server is responsible for taking identification information from the participant, verifying it against the existing database, and, if validated, generating an identification card for the participant to present as a proof of true identify in later communications.

One means of authorization and authentication involves the use of digital certificates in a public key infrastructure (“PKI”). Digital certificates support public key cryptography in which each participant involved in a communication or transaction has a pair of keys, called the public key and the private key. Each party's public key is published while the private key is kept secret. Public keys are numbers associated with a particular entity and are intended to be known to everyone who needs to have trusted interactions with that entity. Private keys are numbers that are known only to a particular entity and are intended to be kept secret. In a typical public key cryptographic system, a private key corresponds to exactly one public key.

Within a public key cryptography system, since all communications involve only public keys and no private key is transmitted or shared, confidential messages can be generated using only public information and can be decrypted using only a private key that is in the sole possession of the intended recipient. Furthermore, public key cryptography can be used for authentication, i.e. digital signatures, as well as for privacy, i.e. encryption. Encryption is the transformation of data into a form unreadable by anyone without a secret decryption key. Encryption ensures privacy by keeping the content of the information hidden from anyone for whom it is not intended, even those who can see the encrypted data. Authentication is a process whereby the receiver of a digital message can be confident of the identity of the sender and/or the integrity of the message. For example, when a sender encrypts a message, the public key of the receiver is used to transform the data within the original message into the contents of the encrypted message. A sender uses a public key to encrypt data, and the receiver uses a private key to decrypt the encrypted message.

When authenticating data, data can be signed by computing a digital signature from the data and the private key of the signer. Once the data is digitally signed, it can be stored with the identity of the signer and the signature that proves that the data originated from the signer. A signer uses a private key to sign data, and a receiver uses the public key to verify the signature.

A digital certificate is a digital document that vouches for the identity and key ownership of entities, such as an individual, a computer system, or a specific server running on that system. Digital certificates are issued by third party certificate authorities. A certificate authority is an entity, usually a trusted third party to a transaction, that is trusted to sign or issue certificates for other participants or entities. The certificate authority usually has some kind of legal responsibilities for its vouching of the binding between a public key and its owner that allows one to trust the entity that signed the digital certificate. There are many such certificate authorities, such as VeriSign and Entrust. These certificate authorities are responsible for verifying the identity and key ownership of an entity when issuing the digital certificate. If a certificate authority issues a certificate for an entity, the entity must provide a public key and some information about the entity. The certificate authority will then generate the digital certificate and return it. The digital certificate may contain other information, such as dates during which the certificate is valid and a serial number. One part of the value provided by a certificate authority is to serve as a neutral and trusted introduction service, based in part on their verification requirements. Typically, after the certificate authority receives a request for a new digital certificate, which contains the requesting entity's public key, the certificate authority signs the requesting entity's public key with the certificate authority's private key and places the signed public key within the digital certificate. Anyone who receives the digital certificate during a transaction or communication can then use the public key of the certificate authority to verify the signed public key within the certificate. The intention is that an entity's certificate verifies that the entity owns a particular public key. The X.509 standard is one of many standards that defines the information within a certificate and describes the data format of that information.

As can be appreciated, conventional PKI systems require that the certificate authority have a back-end hosting infrastructure, while the end user is responsible for registration and technical support functions. Such PKI systems require an enterprise to perform its own native authentication and customer support. Other problems associated with existing PKI systems are generally high cost and poor scalability. Thus, there is a need for a low-cost, scaleable, and completely outsourced method and system for providing trusted communications in corporate extranets and other contexts. The present invention overcomes the disadvantages which have slowed PKI implementation and acceptance. The present invention is able to implement PKI security capabilities, including authentication, authorization, encryption, and digital signatures, while reducing or eliminating the administrative and technical burdens associated with PKI. For example, the present invention enables participants to self-register using the ICS, thereby reducing administrative and technical burdens. Further, because the present invention does not use the PKI-type digital certificate process, there is no need to buy, track, revoke, and distribute digital certificates or undertake the other tasks associated with the PKI methods and systems.

Further, while PKI methods and systems require extensive application programming services for each supported application, the present invention does not require extensive application programming. Further, a conventional PKI-type method and system requires use of specialists who must be able to install, maintain and administer multiple systems. Once a PKI security solution is installed, daily administration is required. In contrast, no special expertise is needed to install, maintain or administer the software that implement the present invention. The present invention permits an enterprise to create its own set of security policies and rule constructs at the TREM level and because participants self-register using ICS, initial administrative burdens are minimized. The following references describe a variety of methods and systems in which trusted collaboration has been implemented and how the present invention is distinguishable and improves upon such methods and/or systems.

In U.S. patent application Ser. No. 10/192,753, by Malinen, et. al., a system and method for three-party authentication and authorization is disclosed. In the Malinen disclosure, a client requests services from a service provider and the authorization of the client for using the requested services can be granted by a third authorizer. Malinen discloses an authorizer that authorizes requestors, a client that makes a request, and a local attendant that provides a conduit through which messages between the client and authorizer pass. The disclosure of Malinen is a trust model that is limited to Internet Protocol version 6, a network-layer service protocol. The Malinen invention focuses on how to authenticate a client that is requesting a service and how a client can be authorized by a separate authorizer, instead of the service provider itself, over IPv6, whereas the present invention provides a protocol independent mean of verifying the true identity of participants performing data exchange or data access. The task of authorizing the service requestor is left to the application that provide the services. Further, the present invention does not require any designated conduit for passing messages between two ends of the communication channel.

In U.S. patent application Ser. No. 09/874,649, by McCown, et. al., a method that prevents piracy of copyrighted data by bypassing any unencrypted transmission to a storage device on a computer system is disclosed. In McCown, a computer sends a request to a server to download data to a particular storage device. The server contacts the storage device directly and communicates over an encrypted data channel for downloading data. This is to prevent any third party, including the requesting computer, from intercepting and storing the transmitted data. The invention of McCown is designed to prevent piracy of data by transmitting data over an encrypted data channel between two related parties, a server and a storage device, whereas the present invention does not concentrate on prevention of privacy of downloaded data. Although privacy of data during transmission can be enforced by the present invention via data encryption/decryption mechanisms, this is not the primary objective of the present invention. Instead, it is a methodology of establishing a trusted identification and verification mechanism in data exchange and data access in open networks. Furthermore, the present invention is not limited to securely downloading confidential data from the computer system.

In U.S. patent application Ser. No. 09/821,079, by Bennantar, a method of authenticating a client requesting access to some controlled resources supported by a host system or application is disclosed. In Bennantar, the client must present the authentication data in order to access the resource. The authentication data that is interrogated by the controlled resource is encrypted using the public key of the host system. The encrypted authentication data is contained in an attributed certificate that is generated by an attribute certificate issuing authority. Bennantar discloses a process for preparing and presenting authentication data that is required of the client to access the host system controlled resource for validation. In order to obtain an attribute certificate to access resources at the host, the client has to retrieve a public key certificate associated with a host, extract a public key associated with the host from the public key certificate, encrypt with the public key authentication data for a controlled resource at the host, generate a request for an attribute certificate, store the encrypted authentication data within the request for the attribute certificate, send the request for the attribute certificate to an attribute-certificate-issuing authority, and retrieve an attribute certificate from the attribute-certificate-issuing authority. These steps are performed each time a client requests access to the host controlled resource. Every client has to provide the identification information in identical format, and the certificate is formatted according to the X.509 standard. In contrast, the present invention discloses a flexible and easy method for the client to self-register with the TREM registration server to obtain its identification card prior to performing data exchange and/or requesting access to data and resources. This process is performed once only. The attributes of the identification information provided by the client to TREM is determined by the implementer and is not restricted to any particular format. The identification card generated by TREM does not require the X.509 standard to be followed. At the time when the client is to access a resource, all it needs is to present its identification card as the evidence of a trusted entity. The application of the prior invention is restricted to resource control, whereas the present invention is applicable in any form of data exchange or data access via an IP network, including resource control.

One method of controlling and authorizing multiple users involves issuing a group certificate from a group certificate issuing apparatus on a client side based on original group information and a group certificate verification unit for verifying legitimacy of a group certificate on the server side. In U.S. patent application Ser. No. 09/863,583 by Morikawa et. al., a system of distributed group management for generating authentication information relating to a group to which users belong at a high speed on a client side, and at the same time, wherein a server can verify this at a high speed is disclosed. The system provides a group certificate issuing apparatus for issuing a group certificate on a client side based on original group information and a group certificate verification unit for verifying legitimacy of a group certificate on the server side. The invention of Morikawa et. al., provides a system that is capable of raising the speed of indirect authentication of a group, whereas, the present invention provides a cost effective, flexible, and easy to implement solution of authenticating the true identity of each individual entity participating in data exchange and data access, be it a local or remote end-user client or a business organization. The certificate generation process is not the focus of the present invention. It is only a step that is performed by the TREM during the end user self-registration process.

In U.S. patent application Ser. No. 09/983,493 by Bender et. al., a system for sharing user information in an anonymous manner among different online advertisers is disclosed. The Bender invention associates an identifier with “anonymized” information of the user, and sends the anonymized user information to a receiving party. The information collection process is a unidirectional process as the anonymized data may not be used or collated in any manner to determine the PII (Personally Identifiable Information) of the user. In contrast, the present invention relates to securing data exchange or data access through a trusted identification mechanism. Anonymizing data to prevent it from being used or collated by web online applications is not within the purview of the present invention.

In U.S. patent application Ser. No. 09/863,199 by Weeks, et al., a system or method to reduce the cost and/or complexity of the trust management decision process is disclosed. A trust management system defines languages for expressing authorizations and access control policies, and provide trust management engines for determining when a particular request is authorized. The task of the trust management engine will typically involve evaluating both the request and a set of certificates associated with the request and/or requestor. The invention of Weeks is distinguishable from the present invention in that the invention of Weeks provides a methodology of identifying one or more authorities that are ultimately responsible for granting or denying a particular process request while the present invention is focused on providing a protocol independent mechanism in authenticating the true identity of the participants involved in data exchange or data access process.

In U.S. patent application Ser. No. 10/007,750 by Hericourt, et al., a system and method is disclosed of a workstation connected to a network for verifying the trustworthiness of a certificate. The system of Hericourt determines the identity of the certificate authority by sending the identity to a certificate authority filter. The filter returns information regarding the purported certificate authority and the public key of the certificate authority. The trustworthiness of the certificate authority is determined by reference to the information returned by the filter and by verifying the signature of the certificate using the public key. The present invention is distinguishable from Hericourt in that the present invention does not involve any certificate authority in validating the identification card of the communication participants. The main purpose of the present invention is to authenticate the true identity of the data exchange participants, not the certificate authority.

In U.S. patent application Ser. No. 09/906,460 by Creighton, et. al., a method and system for securing electronic transactions between business participants in a limited access electronic network is disclosed. The limited access electronic network is accessible only to authorized business partners who have obtained corporate digital certificates from at least one certification authority. The identity information of the business participants is first provided by an extranet host to a certificate authority. The certificate authority authenticates the identity of an authorized business partner and then issues to the partner a corporate digital certificate to be used as an online credential for accessing the limited access electronic network. Although there are similarities between the invention of Creighton and the present invention, the Creighton invention only has one authenticated certificate for the participants and all participants use this certificate. This only ensures that data comes from the partner location. In the present invention, each partner has a trusted representative and the users trade data via their representatives. The present invention ensures that the data coming from the representative is from a certified user. In the system of Creighton, all the users use one certificate and hence, the system does not enable trusted and authenticated and mobile access. The present invention also allows for remote registration based on information entered by the user that is matched against a database. In contrast to the invention of Creighton, the present invention does not have an agent that must register prior to use. If information is entered correctly then the present invention will accept registration. Further, unlike the one step process of Creighton, in the present invention, registration is a two step process. First, the information is entered and the user receives a mocked up identification card. The user can then create his/her own signatures and pass that signature back to the registration services. Furthermore, the present invention is protocol independent and this feature is not mentioned in the invention of Creighton.

In U.S. Pat. No. 6,487,667 to Brown, a system and method for authenticating users and services communicating over an insecure network is disclosed. Users and services authenticate each other by their pass-phrases which are not revealed during the authentication process. Challenge-response techniques are used to keep the pass-phrases secret. The pass-phrases of users and services are known by an authentication “deity” with which the service communicates to authenticate both users and services. The present invention is distinguishable from Brown in that the present invention authenticates users and services by validating the identification card they present at the time of communication. This identification card is generated during the self-registration process prior to issuing any trusted communication request. Further, there is no challenge-response technique or mechanism involved in the present invention. Further, once the identification card is generated, it is safe-guarded by the end user and is not kept by a third party “deity” as the pass-phrase “diety” used in the invention of Brown.

In U.S. Pat. No. 5,341,426 to Barney et al., a method for establishing a secure communication link between first and second terminals is disclosed. The method of Barney includes the following steps: a step of exchanging a first message which contains information describing encryption devices and communications modes available within the terminals and user authentication information; a step of selecting, in at least one terminal, a common key generation and ciphering algorithm; a step of exchanging a second message for providing data to form traffic keys; and a step of exchanging a third message for synchronizing secure communications and initiating secure communication. The invention of Barney is distinguishable from the present invention in that the present invention is not focused on providing a methodology of securing data privacy via cryptographic mechanism. Instead, the present invention secures data exchange by providing a mechanism to establish a trusted relationship between the participants of data exchange and data access communication via a means of authenticating the true identity of communication participants.

In U.S. Pat. No. 5,339,403 to Parker, a distributed computer system to validate if a user is authorized to access a particular application in the distributed computer system is disclosed. An authentication unit of the system issues a privilege attribute certificate (PAC) representing the user's access rights when the user logs on. When the user wishes to access a target application, he presents the PAC to that application as evidence of his access rights. The application, in turn, passes the PAC to a PAC use monitor (PUM) to validate the PAC. The invention of Parker is distinguishable from the present invention in that the invention of Parker emphasizes controlling the user's privilege in accessing applications in the computer system, while the present invention emphasizes authenticating the user's true identity to determine if the user is trustable in performing data exchange data or accessing data/resources in the computer system. The invention of Parker is focused within the area of access control and the present invention does not have this restriction.

In U.S. Pat. No. 6,381,695 B2 to Kudo et al., a system and method to provide an encryption system for inhibiting the decryption of encrypted data unless a decryption condition is satisfied is disclosed. The decryption enabled time is designated as a decryption condition. The encryption system and method of Kudo with time-dependent decryption is constructed with a time-key certificate manager for issuing a time-key certificate to guarantee that a time for enabling decryption of information is limited. In Kudo, if user A wants to send a message to user B, user A requests a time-key certificate from a time-key certificate manager. The certificate includes disclosure time information. User A encrypts the message using the public key included in the time-key certificate and sends it to user B. When user B receives the message, it requests a decryption key from the time-key certificate manager to decrypt the message. When the current time meets the decryption conditions, the decryption key is transmitted to user B, who can use it to decrypt the data. The method and system of Kudo relates to conditions to decryption whereas the present invention relates to trusted communications between parties without respect to time conditions.

In U.S. Pat. No. 6,134,658 to Multerer et al., an authentication certificate management system that automates the authentication certificate request, grant and installation processes to minimize the number of malformed authentication certificate requests is disclosed. The automation processes is implemented by populating the authentication certificate request with available data and then prompting the user to provide the additional data in a simple manner, verifying the form and format of the input data. The invention of Muterer is distinguishable from the present invention in that the present invention assumes properly formed requests. The invention of Muterer focuses on the process of forming authentication certificate, while the present invention ensures quality and efficient trusted communications between parties using trusted representatives.

In U.S. Pat. No. 6,112,263 to Futral, a method for maintaining security and protection for system memory of an I/O device driver that is to be shared between a number of processes within a computer system is disclosed. Controlled access to the I/O device is provided by managing an authorized list in an I/O processor which is used to keep track of users of the I/O device according to types of claims for access to the I/O device. The invention of Futral is implemented in multiple processes accesses to an I/O device whereas the present invention is implemented to ensure secured data exchange and data/resource access in the computer system via a trusted identity authentication system.

In U.S. Pat. No. 5,553,145 to Micali, an electronic communication system using visible trusted parties is disclosed. The Micali invention relates to the following objects: to provide true simultaneous electronic transactions; to provide electronic transactions having guaranteed simultaneity in two-party scenario with the assistance of a visible trusted party and to provide ideal certified mail wherein the identity of the sender is temporarily withheld from the recipient during the transaction. The invention of Micali is distinguishable from the present invention in that Micali invention implements electronic transactions simultaneously whereas the present invention focuses on ensuring quality and efficient trusted communications between parties using trusted representatives.

U.S. Pat. No. 6,249,867 B1 to Patel describes a method of secured data transmission by having the first party generate a key for the second party to encrypt data to be transmitted to the first party. U.S. Pat. No. 6,236,729 B1 to Takaragi, et al. is a key recovery method and system capable of key recovery without informing a third party of one's own secret key. In other words, this is a method of recovering a lost secret key. U.S. Pat. No. 6,526,509 B1 to Horn, et al. is a method of providing an agreed session code between two computer units for encryption and decryption of data to be transmitted. United States Patent No. U.S. Pat. No. 6,212,634 B1 to Geer, et al. relates to a system for authorizing a computer to access restricted information. The authorizing computer creates a key pair and an authorization certificate for the authorized computer to identify itself in a later attempt to access information stored in the authorizing computer. U.S. Pat. No. 6,279,112 B1 to O'Toole, et al. relates to techniques for controlling transfer of information in computer networks. More specifically, O'Toole discloses a system that allow a server computer to control what information a information source computer can retrieve from a client computer. U.S. Pat. No. 6,141,759 to Braddy relates to a method of distributing, monitoring, and managing information requests among one or more client computers, a first server computer, and one or more secondary computers. The first server computer determines which server computer will serve the request from the client computer. U.S. patent application 2002/0126884 A1 by Rix, et al. is a method of providing a secure communication between two devices by having the first device generate a random key to be transferred to the second device to use for decrypting the subsequent messages to be delivered by the first device.

As can be seen, most of the prior art relates to methods of securing data transmission by applying some cryptographic techniques such as key generation/delivery and encryption/decryption mechanisms. The underlying technology of the present invention is to build up an infrastructure to provide a solution for trusted collaboration so as to enable enterprises, through an open or closed network, to provide true identification, provide trusted data acceptance, provide trusted data exchange, provide an open solution for protocol independent business application integration and migration, and permit continuation of business activities with trusted and non-trusted entities.

The lack of security of data access, acceptance and exchange in current PKI systems and methods is hindering the growth of network collaboration. Remote logon with a participant-ID and password combination does not guarantee true identity leaving enterprise data vulnerable to unauthenticated access, spam messages, infected e-mail from non-trusted sources, unauthorized web site access, unprotected wireless device access, and unsecured peer-to-peer or program-to-program data exchange.

There are a number of challenges associated with resolving issues of participant identification when exchanging information across a corporate intranet or the Internet. PKI mechanisms, which provide digital certificates for user identification, continue to experience issues with regard to usability, scalability, and manageability. With PKI, an enterprise must architect, design and implement a security infrastructure which requires a significant level of expertise and cost. Typically, the PKI must be set up and maintained throughout the enterprise for each application. This process is inflexible and costly.

The present invention, advantageously, is a flexible and less costly method and system of facilitating trusted communications. The present invention comprises a method and system of identifying the transmitter of data so as to ensure the transmitted data is from a trusted entity. The present invention advantageously permits enterprise administrators and participants who desire to provide and obtain trusted exchange to obtain true identification of their participants. The present invention can be adapted to perform encryption and decryption on data to be transmitted. Encryption/decryption is merely one of the steps that can be performed by the present invention during the process of trusted communication. The true identification mechanism of the present invention is an improvement over PKI systems in that the enterprise, not a third party, determines how the identification and implementation will occur. This is advantageous because enterprises are best positioned to identity participants who require access to resources. The present invention can be implemented on a variety of hardware platforms. Further, it should be appreciated that the present invention can be implemented in numerous ways, including as a process, an apparatus, a system, a device, a method, a computer readable medium, or as a combination thereof. In addition to being able to be implemented on a variety of hardware platforms, the present invention may be implemented in a variety of software environments. A typical operating system may be used to control program execution within each data processing system. For example, one device may run a Unix® operating system, while another device contains a simple Java® runtime environment. A representative computer platform may include a browser, which is a well known software application for accessing hypertext documents in a variety of formats, such as graphic files, word files, Hyper Text Markup Language (HTML), Handheld Device Markup Language (HDML), Wireless Markup Language (WML), and various other formats and types of files.

### BRIEF DESCRIPTION OF THE INVENTION

The present invention comprises a novel method and system for enabling secure communication over a computing network so as to facilitate and implement trusted collaboration. One embodiment of the present invention is implemented over a client/server computer network with two primary software modules, ICS and TREM. The present invention is an improvement over burdensome PKI methods and systems of establishing identification, authentication and authorization.

### BRIEF DESCRIPTION OF THE FIGURES

FIG. 1 depicts a conventional telephone open system component and objects list;

FIG. 2 depicts the conventional telephone open system in operation;

FIG. 3 illustrates the security architecture of the present invention.

FIG. 4 illustrates the TREM architect model of the present invention;

FIG. 5 illustrates the operation of the ICS of the present invention;

FIG. 6 is a flow chart depicting the process of trusted registration using the present invention;

FIG. 7 illustrates the placement of the ICS of the present invention relative to software applications;

FIG. 8 is a flowchart depicting the steps in which trusted collaboration is established using the present invention;

FIG. 9 is a flow chart depicting the present invention's process of determining whether to send data to a remote location;

FIG. 10 depicts the trusted relationships and administration model of the present invention;

FIG. 11 depicts the process for delivery of data to a non-trusted entity;

FIG. 12 is a flow chart depicting the process of delivery of non-trusted data to an alternate machine;

FIG. 13 is a flow chart describing the process for delivery of data to a non-trusted entity;

FIG. 14 is a block diagram depicting the open system components and objects list of the present invention;

FIG. 15 is a block diagram depicting the placement of the trusted collaboration server of the present invention in the an open system;

FIG. 16 depicts the placement of the services of the present invention in the layers;

FIG. 17 illustrates data wrapping using the present invention; and

FIG. 18 is a flow chart depicting the process of acceptance of data using a conventional PKI product.

### DETAILED DESCRIPTION OF THE INVENTION

One embodiment of the present invention is implemented over a computer network, comprised of servers and clients, using software modules. The modules each implement a different aspect and processes of the present invention.

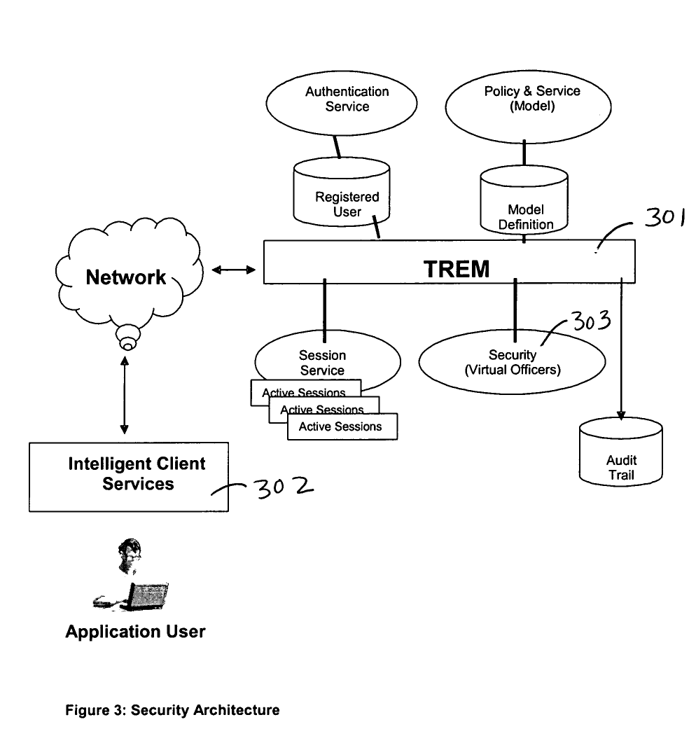

As seen in FIG. 3, the two primary software modules of the present invention used to implement trusted collaboration in a virtual open market are the trusted remote engine manager (“TREM”) 301 and the intelligent client services (“ICS”) module 302. Generally, TREM resides on an enterprise server and ICS resides on a client PC. Using ICS and TREM, and their related sub-modules, several security processes are implemented, including registration, identification, authentication and authorization.

During set-up, TREM prompts the enterprise administrator to set up its own applicable security policy and rules that govern participant access, identification, authentication and authorization. TREM points to a secure configuration file that contains data elements for the participant to use when performing client side registration. One or more participants download and install the client software, ICS on their PCs. ICS enables participants to self-register on their PCs using an intuitive GUI interface thereby reducing administration burdens.

Advantageously, no application programming is required to implement either the ICS or TREM. Existing data elements are used to register participants. When incorporated into a network computing environment, the present invention allows multi-faceted scalability with computer/network resources and implementation, administration, and integration with external enterprises and participants. The present invention's method of processing identification eliminates the need for multiple certificate authorities, greatly simplifying authorization and authentication procedures.

Referring back to FIG. 3, a client/server architecture is used to illustrate the implementation of the present invention. TREM 301 resides on a computer hardware server inside the enterprise data center and is provided the highest level of general security protection. The ICS software 302 of the present invention resides on a participant PC. TREM 301 serves as the control center and performs certain functions more fully described herein. These functions include inspecting and validating identification card information; validating virtual security officer(s) 303 signatures (as further described herein); determining if the request being received is from an authenticated user; based on model definition (policies and rules), determines placement of non-secure data; keeping participant audits; notifying other managers or service components for alternative processing such as access control, rules and policies and encryption key agreements; and auditing all processes.

The virtual security officer(s) 303 of TREM 301 replaces cumbersome certificate authorities and eliminates the cost of purchasing digital certificates. All trusted collaboration must proceed through a central virtual security officer(s) 303. The virtual security officer(s) 303 is virtual in nature in that a real person does not inspect each communications. An enterprise decides during set-up or administration time how many virtual security officer(s) 303 are required for collaboration. Each level of virtual security officer gains less risk of intrusion. A physical person or persons will be responsible for creating a set of virtual security officer credentials to be used by the present invention. The reason an enterprise would want to use more than a single virtual officer 303 is to lessen the risk of attack. The virtual security officer(s) 303 validate the requests for registration, generate a type of identification card, sign the identification card, and send the identification card to the requesting participant 302 by placing a copy of the identification card in one of the defined modeled locations.

The participants 302 that have registered are responsible for their own identification card. The term identification card is a set of structured information that is presented on a request for exchange or access. Just as with any identification mechanism, the virtual security officer(s) 303 have the right to expire or deny access. During session processing the virtual security officer(s) 303 validates the identification data that was sent to determine if in fact the participant 302 is a trusted party. This is determined based on the participant 302 being established in the trusted registry and the identification information having been signed by an approved virtual security officer(s) 303.

A virtual security officer(s) 303 validates requests for registration; generates identification cards; validates the identification card; sends the identification card to the participant; locates a copy of the identification card in one of the defined model locations in a database; accepts incoming session requests; approves or denies the requests; negotiates external and internal exchanges; and applies participant-defined rules to data traffic. The virtual security officer(s) 303 of TREM 301 counter-signs the identification information and thereby validates it.

ICS 302 performs certain functions as more fully described herein. These functions include self-registration; private signing key and verification; authentications; MAC generation for data integrity; electronic signatures placement; and data encryption/decryption. The client/server architecture coupled with the unique security architecture of the present invention as seen in FIG. 3 provides for superior scalability. Initial registration burdens are alleviated due to self-registration by the participants at the ICS level. Revocations are flexible and can be done manually or by interfacing with enterprise systems such as the human resources department so as to revoke access when a participant leaves the enterprise.

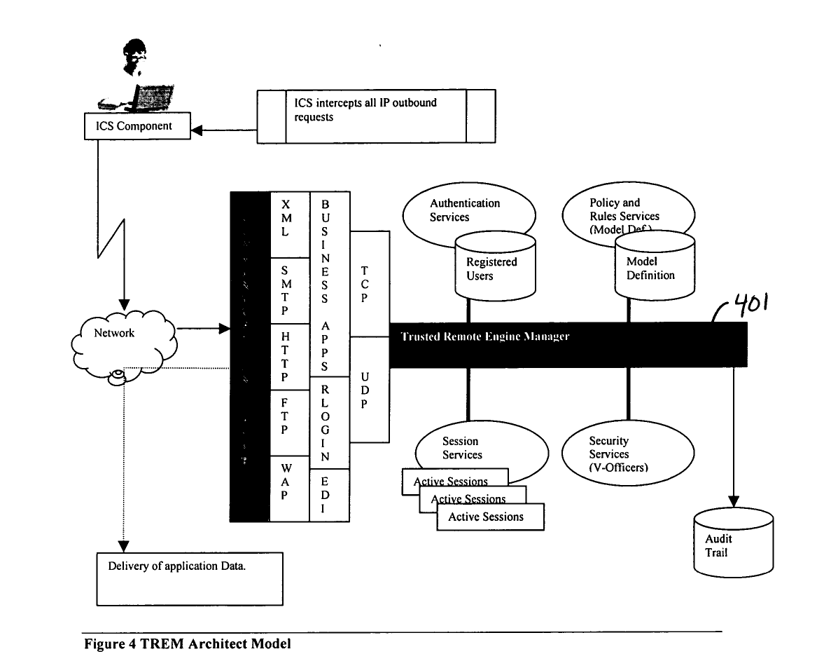

FIG. 4 illustrates the TREM architect model of the present invention. As seen in FIG. 4, TREM 401 ensures that requests are processed as the business model or project model dictates. TREM 401 inspects the identification information; validates officer signatures; validates trusted participation; determines if the request being sent is to a trusted registered party; determines if the request being received is from a trusted registered party; based on model definition, determines placement of non-trusted data; keeps audits of who has done what, when, where and how; notifies the other managers or service components of alternative processing such as access control, rules and policies and encryption key agreements; and performs audits on all processes. TREM, as the control center to all other components, allows for easier diagnostics, easier maintenance, and smoother upgrades and allows for component shutdown, such as the registry services while still allowing trusted collaboration to continue. The system and method of the present invention, as a whole, permits the placement of security sensitive components on other computers. The authentication servers and security services could reside on a platform on which only system security administrators have access.

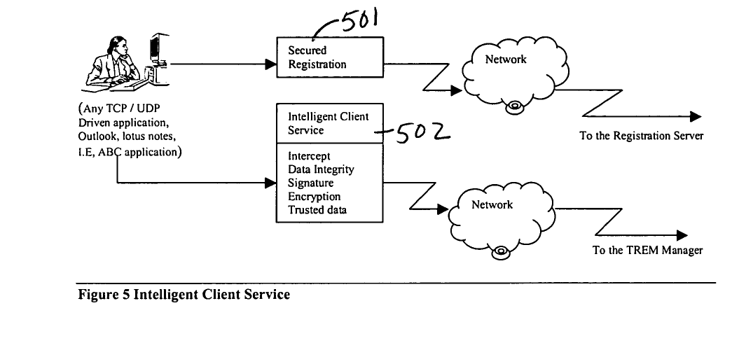

FIG. 5 illustrates the operation of the ICS of the present invention. Conventionally, all acceptance or rejection processing must be performed prior to a client interface. In the present invention, an ICS is different than just a client interface, in that an interface only provides visual interaction. Within the present invention, the ICS provides both external and internal processing. As seen in FIG. 5, ICS performs many functional parts of the present invention's processes. The ICS interface permits dynamic trusted registration, a one-time process. Using ICS, it is the responsibility of each participant to generate a private signing key and a public verification key. Optimally, the private key never leaves the participant. This signing key is stored with the identification data and can be stored on any media, such as a diskette, CD, smart card, or on a PC hard drive. The identification data is encrypted using a pass-phrase known only by the participant. The virtual security officer(s) 303 also signs the identification information. If the participant forgets their pass-phrase for signature usage then they must re-register with the system. The pass-phrase can be any combinations of words or phrases that helps the participant remember the pass-phrase. The registration definition dictates the minimum length of the pass-phrase. The less number of characters in a phrase, the more vulnerable the system is to attack. The internal functionality of the ICS provides: interception of TCP/UDP data; generating a MAC for data integrity; signing the MAC; performing encryption key agreements and data encryption; and performing trusted and non-trusted data placement. The ICS is a two-part service. As seen in FIG. 5, the first part 501 allows for individual setup and the second part 502 performs intelligent processing. Because the internal service lies between the application and the end point solution, the client service is easily integrated with new and existing business applications.

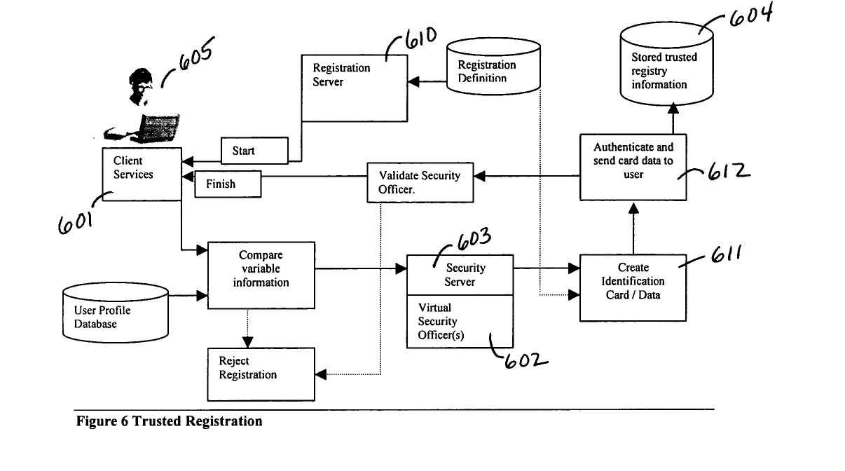

FIG. 6 is a flow chart depicting the process of trusted registration using the present invention. To enable application processes or products to identify participants, the participants must perform trusted registration. This involves providing information known only to the participant and a secured set of defined information. The information used may be based on social security number, driver license number, mother's maiden name, passport, employee ID number, registration key, etc. The information is dynamic in nature and is different based on each business model or project model. Allowing an enterprise to decide the model for trusted registration provides true separation of trusted management. Separation enables companies to dictate external registries different than they would for internal registries, permitting controlled or total external shutdown where collaboration has been compromised without affecting other processes. However, this does not mean that an application or individual must register for each type of collaborative process. Registration in the present invention is a one-time identification process. In the present invention, identification information is analogous to digital certificates in the typical-PKI method. Digital certificates contain the verification for signature and the signature of a certificate authority. In a PKI-type method, digital certificates created by a certificate authority are placed in an open location that permits open access. The present invention manages identification information more efficiently and effectively than typical PKI methods and systems. Advantages of the present invention over PKI methods and systems include the method of how identification information is accessed, who has responsibility for the identification data and who validates the information. In the present invention, identification information is created at the time of registration for a participant by a central security authority, the virtual security officer(s) 303. FIG. 6 provides a flow chart that illustrates the process of trusted registration. As seen therein, the registration server 610 creates an identification card 611 which is issued to the participant in step 612 and which they are responsible for safeguarding. The identification card 611 is a set of structured information that is presented on a request for exchange or access. A configuration file is used for model definitions, which includes, at a minimum: attribute definitions for trusted representatives to compare; data storage locations for the trusted representatives to compare; data storage locations to store the trusted registry information 604; a registration server 610 to authenticate incoming registry requests and to dictate the model; a security server 603 to approve the requests; and an ICS 601 allowing for dynamic data entry and trusted exchange for secured registration. The foregoing illustrates a simple but secure method for trusted and secured registration. As seen therein, the virtual security officer(s) 602 have been created and information only known to the participant 605 and the registration server 610 have been defined and the participant has installed the ICS 601 on the PC. ICS 601 displays the model definition information to the participant 605 and the participant 605 enters all required information defined in the model definition. In this way, the participant 605 creates a signing key and a verification key. The verification key is stored in the trusted registry 604. Optimally, the signing key never leaves the participant's possession. In operation, and using ICS the participant generates a private signing key and a public verification key. The private signing key is stored with the identification card 611 data. This data can be stored on a media including a diskette, PC or smart card. The identification card data is encrypted using a pass-phrase known only to the participant. Thus, even if the identification card data is stolen or lost, access is restricted unless the participant's pass-phrase is known. An enterprise may decide that the registration of external participants should reside in a separate location from internal participants and that internal and external application processes reside in different locations. The present invention is more efficient and effective because it eliminates the requirement for every enterprise or participant to have access to the database of identification card information. In operation, the present invention validates the sending participant prior to receiving any data thereby eliminating the need to access the database at the time the acceptance is being performed. Referring back to FIG. 6, the information is encrypted and passed back to the registration server 610 for comparison. The registration server 610 validates all input fields and the signature of the participant 605. Upon validation, the registration server 610 forwards a request to the security server 603 to generate identification information, which is referred to as the identification card 611. The security server 603 generates the identification card 611, signs the identification card 611 and stores a copy in the trusted registry 604. The security server 603 then passes the identification card 611 back to the registration server 610. The registration server 610 validates the signature of the virtual security officer(s) 602 and upon validation passes the identification card 611, in encrypted form, back to the participant 605. The participant 605 is prompted to enter a pass phrase to encrypt the identification card 611 information and the participant's signature. The identification card 611 is then stored on secured media.

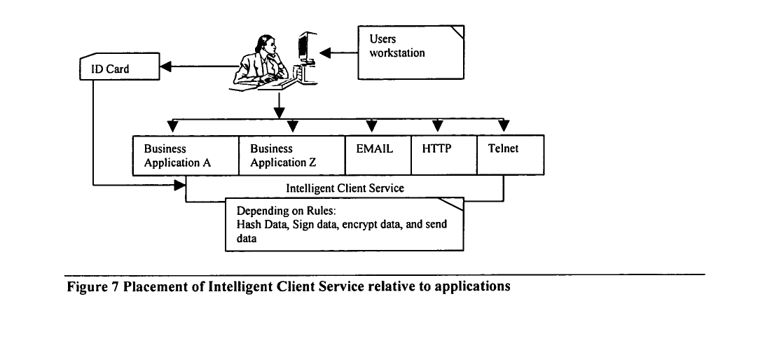

As seen in FIG. 7, once the initial registration is complete, the client interface is no longer used unless a virtual security officer, enterprise or participant determines that the private and verification keys have been compromised. The internal client service takes over to perform trusted collaboration. The intelligent client service facilitates application-to-application collaboration without participant interaction. A unique registration model is set up for individual applications. FIG. 7 illustrates the placement of the ICS of the present invention relative to several software applications. FIG. 7 illustrates the placement if the ICS relative to any business application that is communicating over an IP network. Once registration is complete then the participant is free to use all other applications just as they normally would. The ICS traps the information, performs data hashing for integrity, signs the data for non-repudiation, encrypts the data for security and sends the data. The placement of the ICS between the applications layer and network layer allows participants to operate normally without regard to underlying methods. Further, the ICS does not require a participant to use a separate interface for processing.

To more fully describe the operation of the present invention, an e-mail application used to communicate sensitive information is described. However, the description using an e-mail application should not be construed as limiting as the present invention can be adapted to other applications, including banking, security trades, and health care privacy communication. Collaboration can occur among different types of clients using the same protocol or steps for communications. E-mail is a good example of how collaboration through technology can occur between differing end points using the same protocol. However, unless each participant in the collaboration is using the same set of identical tools i.e., e-mail exchange products, trust cannot occur. Further, a potential hacker could obtain named addresses and spam a virus to all known names causing infection to occur only because an innocent participant thought they were receiving data from a trusted source. In open environments, such as e-mail, there is no way to keep collaboration from occurring unless you know the e-mail addresses that you wish to exclude or include. Thus, it is desired to have an open system and method that will enable trust for the acceptance of data, access to data and identification of the sending participant—the administration and processing of trust being removed from the client and placed at the server. TREM determines the level of trust and delivers the collaboration based on policy rules. The present invention advantageously maintains a level of abstraction for openness of processing, allows trusted and non-trusted collaboration to, occur or not to occur, based on an enterprise's model, keeps the administrative burdens low, allows the switching on and off of collaborative programs for plug and play, places the burden of proof of identity at the participant level, i.e., the ICS; and places the burden of trust at the server level, i.e., at TREM.

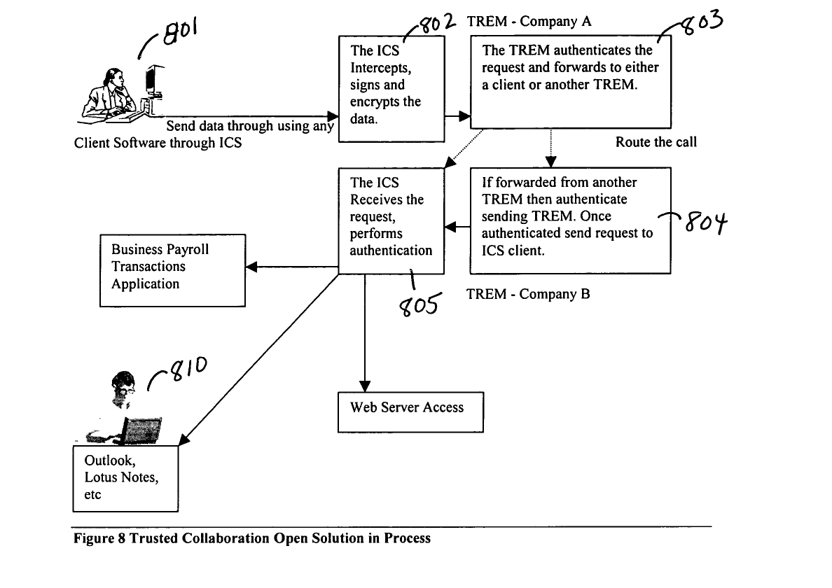

As seen in FIG. 8, a sending participant 801 sends an e-mail pursuant to which the sending participant's ICS of the present invention encrypts the message 802. Encryption is implemented by scrambling the message and creating a message authentication code (“MAC”). In addition, the sending participant 801 is authenticated using a digital signature that is verified by the sending participant's TREM 803. TREM 803 determines if the sending participant 801 is authorized to send to the recipient 810. If authorization is not granted, the message is forwarded to an “information quarantine” area (not shown) for review. If authorized, the digital signature is stored, along with predetermined data, for non-repudiation purposes. TREM 803 acts as a representative and replaces the sending participant's 801 digital signature with the representative signature and passes it to the recipient 810 over the computer network. TREM 803 authenticates the recipient 810 and sends the message. The recipient's TREM 804 authenticates the signature of the sending TREM 803 and, if authenticated, replaces the signature of the sending TREM 803 with its signature, decrypts the message and forwards it to the recipient 810 via the recipient's ICS 805. The recipient's ICS 805 authenticates the signature of its TREM 804 and delivers the message to the recipient 810. The recipient 810 receives the message as they normally would have had the present invention not been implemented. If authentication can not be accomplished, the message is sent to quarantine (not shown). As can be seen, no special programming skills are required to implement the present invention, and the recipient 810 and sending participant 801 are not impacted.

A model is “a definition of attributes, policies and rules governing a business process or a project process”. The model definition can differ for each process. This allows for full flexibility in process integration. For example, communications processing on a computer system has its own address, known as the IP address, and each application has its own port for delivery. E-mail could contain a model definition that states, “Any incoming request that is not authenticated, i.e., not trusted, will not be delivered to the receiving participant and will be routed to information quarantine for review.” This process occurs at the server level. The participant need not be involved, although the participant may be notified of the action based on defined rules. Either the enterprise administrator or the recipient redirects the incoming request. A business application that stores transactions for later processing could have a definition that provides that all non-authenticated data is redirected to an alternate directory. This enables the business applications to process data and ignore and delete the non-authenticated data; re-direct and review the data by human interaction for next day processing, or perform automated alternate program execution for non-authenticated data delivery. Automated services could include e-mail alerts or pager calls. Suspect communications are sent to an information quarantine area and isolated from the participants and system based on the application of enterprise/participant defined rules. Suspect communications might include non-validated sending participants or spam e-mail. Upon entering information quarantine, an e-mail notification is sent to the intended recipient. The present invention flexibly enables the enterprise or participant to determine how the information is released from quarantine or destroyed. The present invention can also be adapted to implement biometric security, or other forms of security.

As noted, a model definition can differ for different processes. Just as telephone service permits each individual telephone to implement call blocking, call forwarding, etc., each collaboration link can define its own set of rules. This allows for full flexibility in process integration. Some models may require an encryption key to be entered before transmission time while other models may require an agreement be made between processes at transmission invocation. For example, because of the potential for e-mail to be sent through several Message Transfer Agents, some potentially controlled by hackers, before it reaches its final destination, it may be better to have a participant type in the key and have the key encrypted with the data as it passes through to its final destination. This restricts hackers from spoofing a key exchange and also speeds the process of transmission. For those business applications that would process in a batch mode, it may be best that a key exchange take place.

The proxy services and interception services of the present invention are governed by the port number definition in a model. For example, an enterprise may determine that port 25, for e-mail output, will always require identification data before the exchange all other ports of communications can operate normally.

The present invention can be adapted to provide application security features including encryption, digital signatures, data integrity, authentication, authorization, world wide web, e-mail, FTP, Telnet, access control, information quarantine, auditing, non-repudiation, policy constructs and rule constructs. Auditing provides the tracing and tracking required by enterprises to determine potential weak points in model definition settings and provide true non-repudiations required for proof of process. In the present invention, audits are performed at critical points including, but not limited to: receiving of requests; rejection of requests; acceptance of requests; registrations; and adds, updates and deletes to any data store element. Sensitive information that could compromise a system are not placed in any audit log file. Further, the actual application data is not placed in any audit log file. Auditing consists of service actions only and includes: date/time stamp; requestor ID; receiver ID; application name; type of request; and status of request.

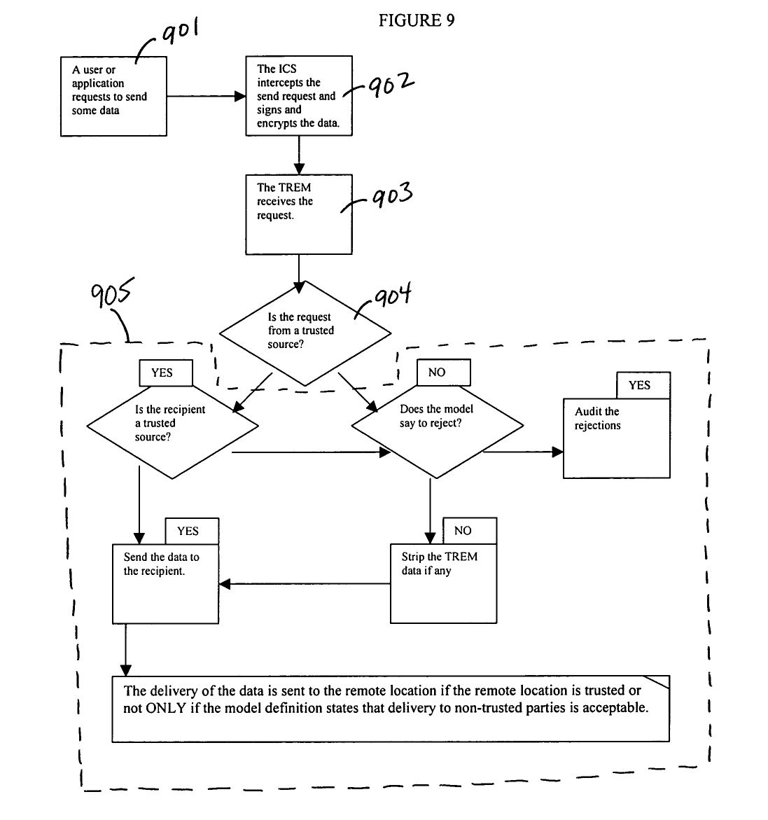

FIG. 9 is a flow chart depicting the present invention's process of determining whether to send data to a remote location. The client applications are any application that has enabled the standard Internet Protocol (“IP”) for data communications. Whether e-mail clients, web browsers, vendor products or core business applications, the client, much like the phone, is independent. The ICS of the present invention proxies the communications request between the client and the main collaboration server. As seen in FIG. 9, the process of trusted collaboration fits with the proven concept for an open solution process. The participant or business application 901, much like the cell phone, issues a request to send, receive or access data. The ICS component 902 intercepts this request and places a signature for authentication and encrypts the information. The TREM component 903, much like the telephone switchboard, receives the request, performs the trusted authentication, the data integrity check and tests for remote client participation 904. The remote ICS receives the request and routes the information to the appropriate application for processing 905.

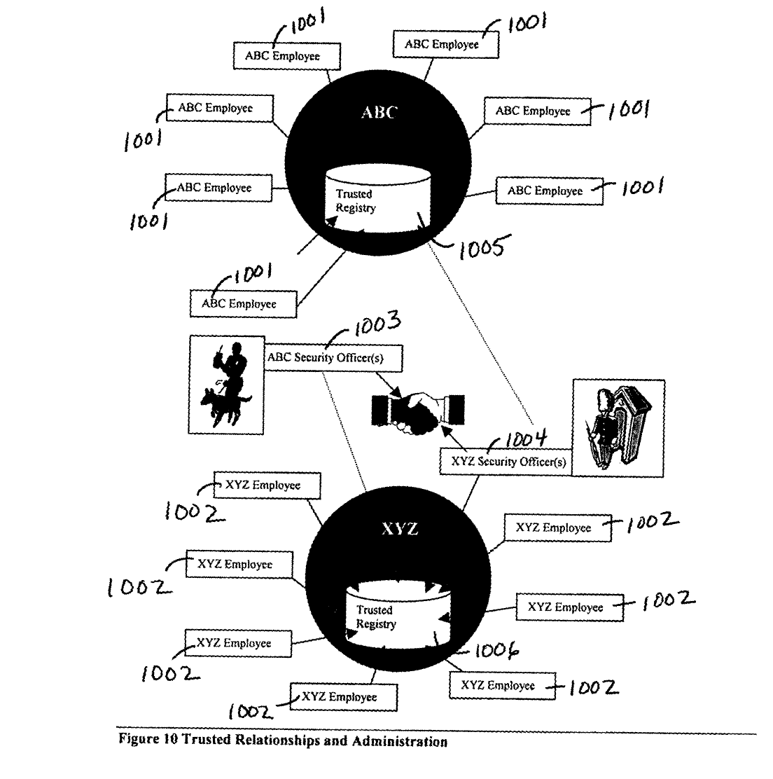

FIG. 10 depicts the trusted relationship and administration model of the present invention. As seen in FIG. 10, each enterprise, which can be a corporation, division, group or similar grouping, is responsible for maintaining their own set of employees 1001 and 1003. The employees form a trusted relationship with their enterprise. The present invention permits simple administration so as to allow each enterprise to administer their own participants. The trusted exchange between enterprises is placed at the virtual security officer(s) level or trusted representative level 1003 and 1004, respectively, eliminating the need for every enterprise, company, division, group and participant to know about each other. Core functionality of the present invention is the ability to identify the sending participants, such as ABC Employees 1001 and receiving participants, such as XYZ Employees 1002, via personal identification data through a trusted representative, seen as ABC Security Officer 1003 and XYZ Security Officer 1004, and trade data or information between those participants 1001 and 1002 via their trusted representatives, 1003 and 1004, respectively. The trusted relationship is established by a trusted registration process through trusted registries 1005 and 1006 performed by the participants with their trusted representatives and/or one trusted representative with another trusted representatives with which it communicates. The registration process results in a digital certificate being created, which is presented by the entity who initiates a trusted communication. For example, during data transmission, a participant, ABC Employee 1001 presents the personal certificate to his trusted representative, ABC Security Officer 1003. If authenticated, the trusted representative, ABC Security Officer 1003 replaces the participant's certificate with its own and processes the data transmission. On the other end of the communication link, if the data receiver is another participant under the same trusted representative, the presence of the representative's certificate is the evidence that data originated from a trusted entity. If the data receiver is a participant under a different trusted representative such as XYZ Employee 1002, the data is transmitted to XYZ Security Officer 1004 as trusted representative. The sending trusted representative, ABC Security Officer 1003 presents it's certificate to the receiving trusted representative, XYZ Security Officer 1004. If authenticated, the receiving trusted representative replaces the sending trusted representative's certificate with its own and processes the data transmission. Again, to the designated participant, the presence of its representative's certificate is the evidence that data originated from a trusted entity. This differs from PKI-type methods and systems, as such methods and systems require every participant to know and trust the sending participant. The trusted representative in the present invention determines both sending and receiving participants trust status prior to data or information delivery.

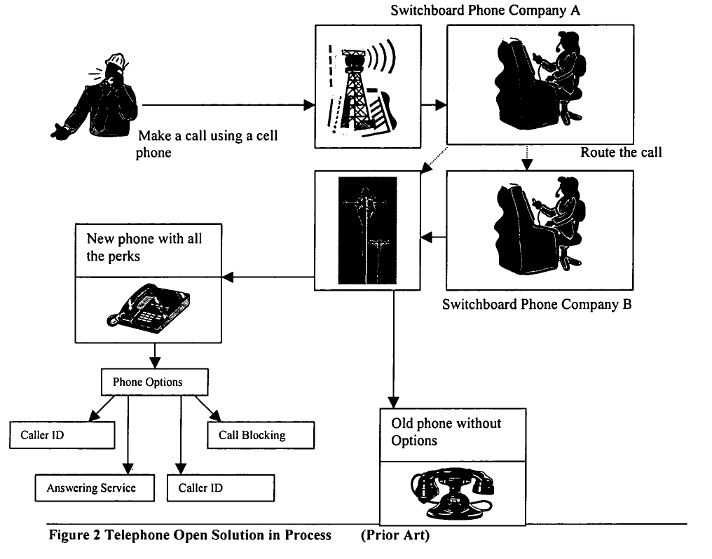

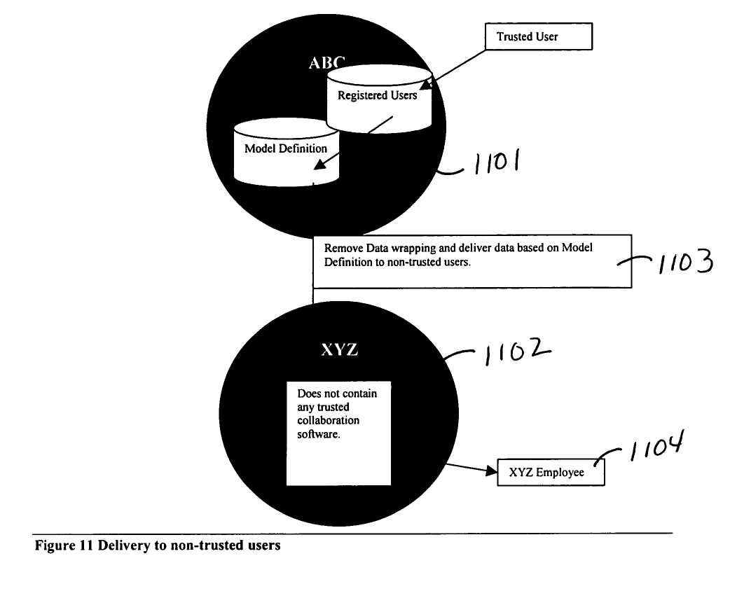

FIG. 11 depicts the process for delivery of data to a non-trusted entity. The present invention enables enterprises through an open or closed network, to provide true identification, trusted data acceptance, trusted data exchange, trusted computer and or data access and an open solution for protocol independent business application integration and migration. Further, it is flexible in that it allows enterprises to continue to perform business activities with trusted and non-trusted entities. To be considered an open environment, a software method must be capable of working with or without certain components while data throughput remains unchanged and deliverable. Like the telephone example of FIG. 2, a participant is not restricted to the type of devices used for collaboration but can use the device type of their choice. Enterprises are able to implement all or part of the present invention while “non-implemented” processes are not affected.

As FIG. 11 illustrates, the TREM definition rules of the present invention govern the delivery of non-trusted data. TREM wraps information around the application data and determines the trust relationship. When the relationship from ABC 1101 is to a non-trusted entity, e.g., XYZ 1102 and the rule model definition states that the information should be sent regardless, TREM will remove the information 1103 before it releases the data. This permits data delivery to occur to external participants, e.g., 1104 that do not have trusted collaboration on their end. This aspect of the present invention allows for the delivery of data and information to non-trusted or non-registered applications. This aspect not only permits the delivery of data to a non-trusted source, but also allows a company to implement a phased in system for enterprise wide security solutions.

As seen in FIG. 9, an application or participant can have the ICS components and still maintain a level of transparency of implementation to the remote side. The remote side does not require notice that the ICS components have been installed or used. Just as delivery can still be accomplished to a non-trusted participant, the acceptance of non-trusted data is also governed by the model definition. For example, assume a hacker, an employee of Hacker company, learns that port 3674 on the payroll computer is used to receive reimbursement transactions for nightly processing and all that is required for access is a formatted message using a participant ID and password combination that has been left on an executive's desk. Now assume port 3674 is directed through the trusted collaboration system and method of the present invention. The transaction would require a digital signature from a trusted participant. The hacker would fail since he/she does not have the executive's signature.

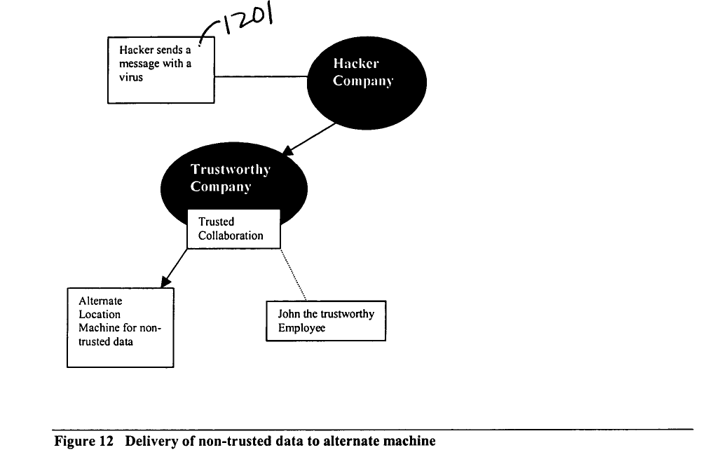

As noted in FIG. 12, the model definition can be set up to re-direct all incoming traffic to an alternate location or directory or reject the request altogether. The model definition can also be defined to accept the data and send the data to the end application.

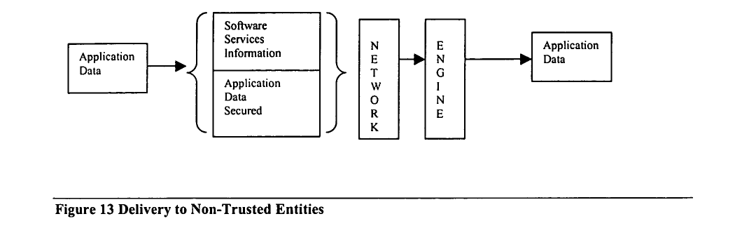

FIG. 12 is a flow chart depicting the process of delivery of non-trusted data to an alternate computer and FIG. 13 is a flow chart describing the process for delivery of data to a non-trusted entity. An additional aspect of the present invention is the ability to direct the activity to a controlled environment for human interaction/investigation. This redirection is important for an enterprise wishing to make certain that the information is trusted data. This process eliminates virus intrusion and permits enterprises alternatives for data processing. For example, a data entry transaction may be created on a daily basis for payroll processing or reimbursement processing. As seen in FIG. 12, if data is received by a non-trusted source then the information is redirected to a secured location as directed by the enterprise.

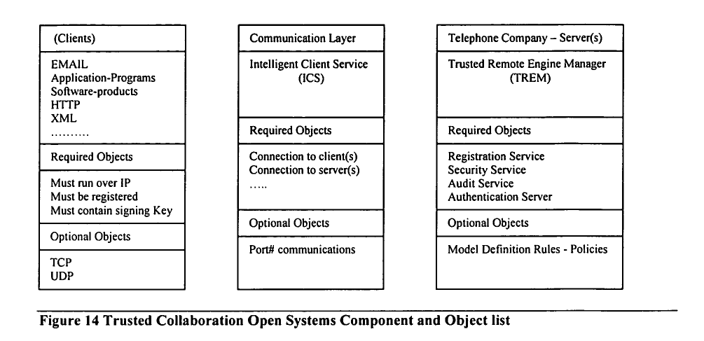

FIG. 14 is a block diagram depicting the open system components and objects list of the present invention.

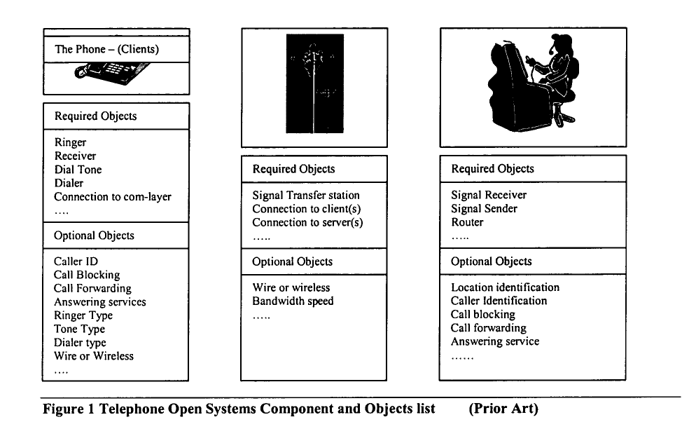

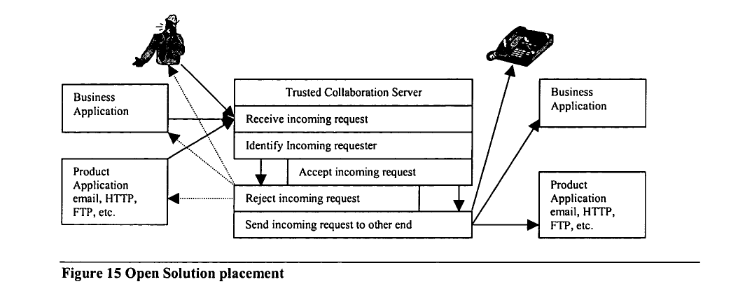

FIG. 15 is a block diagram depicting the placement of the trusted collaboration server of the present invention in an open system. In FIG. 15, the similarities between the present invention and the telephone system of FIGS. 1 and 2 are seen. Referring to FIG. 15, the business and product applications are the client processes much like the physical telephone is to a caller. TREM is analogous to the telephone company in that incoming data or calls are received whenever a request is made. TREM receives the initial request, performs identification on the request, compares the request using enterprise rules and policies much like call blocking and then either sends the request through to the other side or rejects the request.

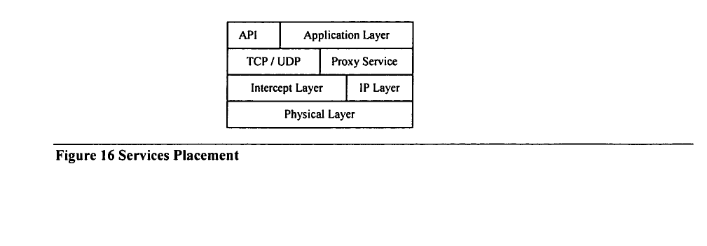

From an architectural viewpoint, a major advantage of the present invention over typical PKI-type methods and systems includes protocol independence and data wrapping which eliminates the need for application programming. The present invention is protocol independent. A protocol is defined as a set of conventions governing the treatment and formatting of data in an electronic communications system. Some protocol standards include XML, HTTP, FTP, SMTP, SNMP, SOAP and EDI. The present invention is protocol independent because of where it is placed in the system. As seen in FIG. 16, placement of the services of the present invention depends on how an enterprise desires to implement it. To provide independence, three different options are provided for application integration and migration: an API set can be supplied allowing enterprises to develop trusted collaboration at the application layer; a set of proxy servers, also known as gateway components, are available for immediate use between existing applications and/or products, and a service that will intercept communications. The last two options provide solutions without enterprise application program modifications.

To provide transparency, the present invention includes a software module that places identification information around the application data before it is sent out onto the network. Once verification for collaboration has occurred, the software module removes its information returning the application data to its original state. The application data delivery is the same as it was when it was first received for processing.

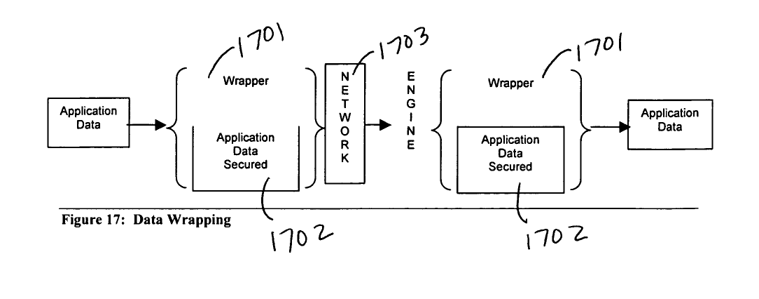

As seen in FIG. 17, the present invention “wraps” identification information 1701, for authentication purposes, around the application data 1700 before it is transmitted into the network 1703. The secured application data 1702 can be encrypted by the present invention. Once verification has occurred, wrapper 1701 is removed returning the secured application data 1702 to its original state 1700. This enables the present invention to be quickly implemented into the application and enterprise. The client will optionally encrypt the application data using private and public key techniques. In addition, the client provides data integrity.

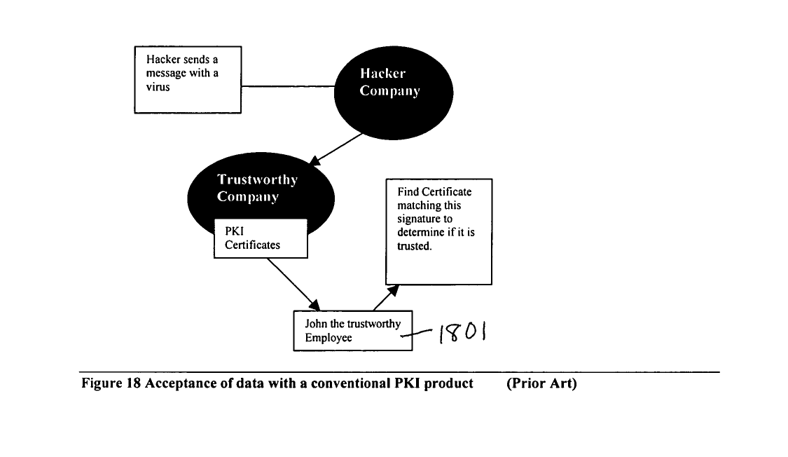

FIG. 18 is a flow chart depicting the process of acceptance of data using a conventional PKI product. As was seen in FIG. 12, a hacker is sending a message to a participant, however the participant never receives the message because the model definition was defined to forward all non-trusted data to an alternate location. Now assume the same scenario using the current PKI offerings. FIG. 18 shows that the hacker is still able to deliver the message to a participant, John 1801. John 1801 must perform acceptance on the data. There is a risk that John 1801 might accept the data, thus infecting his device or PC. The same scenario is true with any business application. Using the present invention, a payroll system is not required to determine if the data is acceptable as this acceptance or rejection occurs prior to receiving the data.

There are a variety of methods to enable external participant relationships using the present invention. If an enterprise has the TREM components installed, the only requirement for external participant integration is for the external participant to install the ICS component at the external participant PC. The external participant registers using the graphical interface component. After registration, the internal components of the ICS will capture the collaboration requests. This allows for external or internal participants to benefit from the service without the requirement of full implementation of the present invention.

The identification card information serves as the participant's passport for trusted collaboration. Because this information can be stored on a variety of media, the participant can move to different locations and still utilize the services. If a participant uses a PC with ICS installed by another participant, all auditing would occur based on the identification card information. This eliminates participant spoofing and promotes non-repudiation.

Performing data encryption, creating message digests for data integrity and signing data is an added layer to time critical methods. Although the disclosed embodiment of the present invention illustrates examples assuming only a single exchange, the services and components are asynchronous in nature, which makes processing and delivery perform at a higher rate of speed. Throughput is enhanced by using validated encryption techniques. Storing critical and redundant data in memory for quicker access and spawning asynchronous processes for processing power.

The advantages of the present invention over existing PKI-type methods include: no development cost associated with security implementation; reduced administrative need for secured data encryption; minimal need to train personnel; no maintenance development for security or audit issues; instant auditing of exchange, access and acceptance to information and computers; and minimal need to develop and maintain separate audits giving auditors immediate information The present invention can be implemented with any IP application giving an enterprise the ability to implement a single solution in all applications and products within an enterprise instead of a single proprietary focus. If used in conjunction with e-mail then the present invention can be used to eliminate spam, virus infections and ensure trusted information and data acceptance. When used within application-to-application data exchanges, the present invention ensures that information is transferred in a secure manner. The present invention can be adapted to automatically route non-trusted data and reject non-trusted access.

Because the present invention assures rules and policy definitions for data delivery regardless of the party sending or receiving, the ability to communicate to application processes, not containing any parts of this product, makes the present invention an open solution. If received data does not contain the required information, and, if the policy is defined to allow the transaction to occur, then communication continues. If data is sent to an application process that is not identifiable, and, if the policy is defined to allow the transaction to occur, then communication continues. Data delivery for both sending and receiving is performed as originally expected. The present invention permits an enterprise to implement the invention on a transitional basis, or with selected participants, based on enterprise or data security requirements.

The innovative teachings of the present invention are described with particular reference to an e-mail embodiment of the present invention, and the applications derived therefrom. However, the present invention can be implemented in a variety of applications. An enterprise may wish to communicate information through application processes to other remote locations or to other business participants. The present invention can be adapted to programmatically sign the data, encrypt the data and perform an exchange between the TREM components. The only requirement for setup is that each participant to the transaction perform a trusted registered relationship. FTP, HTTP or remote logon access are other examples of applications in which the present invention can be implemented. Having the requestor sign the initial request, then having the present invention perform validation places an extra layer of security not normally available. With the present invention, enterprises can make certain that an information request is from a trusted source. When the communications is through IP, the present invention enables true identity for data acceptance, access and exchange. It should be understood and appreciated by those skilled in the art that the arrangement, use, and embodiment described herein provides only one examples of the many advantageous uses and innovative teachings herein. Various alterations, modifications and substitutions can be made to the system and methods of the disclosed invention and the software that implements the present invention without departing in any way from the spirit and scope of the invention.

What is claimed is:

1. A trusted collaboration data transmission process and protocol, comprising:
establishing one or a plurality of trusted participants a participant who desires to initiate and send or receive a trusted communication;
establishing one or a plurality of trusted representatives to act on behalf of the trusted participants;
performing a trusted registration procedure to create registry information and to establish a trusted relationships between trusted participants and trusted representatives;
performing a trusted registration procedure to establish a trusted relationship among trusted representatives;
creating an identification card correlating to each of the trusted participants and each of the trusted representatives, during the trusted registration process;
factually identifying a trusted participant as a sending participant through the sender identification card sent to a sender trusted representative, which is the trusted representative of the sending participant;
factually identifying a trusted participant as a receiving participant through the registry information of the receiving participant or the receiver trusted representative, which is the trusted representative of the receiving participant;
presenting the sender identification card to the sender trusted representative prior to or during a data transmission;
authenticating the sending participant by examining and confirming the sender identification card;
replacing the sender identification card with a sender trusted representative identification card, if authenticated;
applying rules and policies to determine how to process transmission request coming from a non-trusted or unauthenticated participant;
blocking the transmission or processing the transmission without presenting the sender trusted representative identification card if sending participant is not authenticated;
authenticating the receiving participant, if not authenticated, by either blocking the transmission or processing the transmission without presenting the sender trusted representative identification card, pursuant to certain rules and policies;
processing the data transmission with or without a sender trusted representative identification card;
if a receiving participant of a data transmission is not an trusted participant, delivering the data to the recipient in its original format;
if a receiving participant is a trusted participant and is under the same trusted representative as the sending participant, presenting the sender trusted representative identification card to the receiving participant;
if the receiving participant is a trusted participant and is under a different trusted representative, presenting the sender trusted representative identification card to the receiver trusted representative;
upon receipt, replacing the sender trusted representative identification card with the receiver trusted representative identification card;
acknowledging a data transmission by the receiving participant or receiver trusted representative end of a communication link by the receiving participant or receiver trusted representative;
processing the data transmission;
confirming the presence of the receiver trusted representative digital certificate in the transmitted data; and
confirmation comprising evidence that the data transmission is coming from a trusted entity.

2. The trusted collaboration data transmission process and protocol of claim 1, further comprising a multi-way communication during which the sending participant(s) and the receiving participant(s) switch roles during the communication depending upon whether the participant is initiating a data transmission or receiving a data transmission.

3. The trusted collaboration data transmission process and protocol of claim 2, further comprising being implemented using computer hardware and software.

4. The trusted collaboration data transmission process and protocol of claim 3, wherein:
the sending participant is a software application or an end-user client;
the receiving participant is a software application or an end-user client;
the sending trusted representative is a software component consisting of a set of rules and policy constructs;
the processing logics of the enterprise controlling the sending participant; and
the receiver trusted representative is a software component consisting of a set of rules and policy constructs; and
the processing logics of the enterprise controlling the receiving participant.

5. The trusted collaboration data transmission process and protocol of claim 4, wherein:
actions of the receiving participant and sending participant are initiated at a client level; and
actions of the receiver trusted representative and sender trusted representative are initiated at a server level.

6. The trusted collaboration data transmission process and protocol of claim 5, wherein the sending participant and the receiving participant are communicating over a computer network.

7. The trusted collaboration data transmission process and protocol of claim 3, wherein:
the sending participant is an individual acting through a software interface;
the receiving participant is an individual acting through a software interface;
the sending trusted representative is software component consisting of a set of rules and policy constructs and the processing logics of the sending participant's enterprise; and
the receiver trusted representative is a software component consisting of a set of rules and policy constructs and the processing logics of the receiving participant's enterprise.

8. The trusted collaboration data transmission process and protocol of claim 7, wherein:
actions of the receiving participant and sending participant are initiated at a client level; and
actions of the receiver trusted representative and sender trusted representative are initiated at a server level.

9. The trusted collaboration data transmission process and protocol of claim 8, wherein the sending participant and the receiving participant are communicating over a computer network:

10. The trusted collaboration data transmission process and protocol of claim 1, wherein the trusted registration process to establish a trusted relationship between a participant and a trusted representative and between a trusted representative and another trusted representative is implemented using an intelligent client services software module resident on a participant PC and a TREM resident on an enterprise server.

11. The trusted collaboration data transmission process and protocol of claim 10, wherein:
a registration server creates the registrant identification card, be it a individual participant or a remote trusted representative;
the identification card comprises a set of structured information that is presented on a request for exchange or access;
a configuration file is used for model definitions, which includes attribute definitions for the sending trusted representative and receiver trusted representative to compare to the sender identification card and receiver identification card;
a data storage location for the sending trusted representative and receiver trusted representative to compare to the sender identification card and receiver identification card;
the data storage location to store the trusted registry information;
the registration server to authenticate incoming registry requests and to dictate the model;
a security server to approve participant requests; and
the intelligent client service allowing for dynamic data entry and trusted exchange for secured registration.

12. The trusted collaboration data transmission process and protocol of claim 1, wherein the trusted registration process further comprising:
creating a sender identification card correlating to the sending participant during the trusted registration process using an sender intelligent client services software module; and
creating a receiver identification card correlating to the receiver participant during the trusted registration process using an receiver intelligent client services software module.

13. The trusted collaboration data transmission process and protocol of claim 12, wherein the sender identification card correlating to the sending participant is secured using a pass-phrase.

14. A trusted collaboration data transmission process and protocol, comprising:
identifying a sending participant through personal identification data sent through a trusted representative;
identifying a receiving participant through identification data sent through a trusted representative;
establishing a trusted relationship by a trusted registration process performed by the participants with their trusted representatives and/or one trusted representative with another trusted representatives with which it communicates;
creating a digital certificate in the registration process which is presented by the participant who initiates a trusted communication;
presenting the personal certificate to the trusted representative during the data transmission;
replacing the participant's certificate with the trusted representative's certificate, if authenticated;
processing the data transmission;
acknowledging the transmission on other end of the communication link by the receiving participant or its trusted representative;
presenting the sending participant's trusted representative certificate to the receiving participant trusted representative;
the receiving participant trusted representative replacing the sending participant's trusted representative's certificate with its own and processing the data transmission; and
the presence of the trusted representative's certificate in the transmitted data being evidence that data is coming from a trusted entity.

15. The trusted collaboration data transmission process and protocol of claim 14, further comprising the actions of the participants being initiated at a client level; and
actions of the trusted representatives being initiated at a server level.

16. The trusted collaboration data transmission process and protocol of claim 15, wherein the participants and trusted representatives are communicating over a computer network.

17. A method for an authentication process within a distributed data processing system, the method comprising trusted registration, identification, authentication and authorization actions of a trusted remote engine manager and a virtual security officer sub-module, resident on a computer server, and identification, authentication and authorization actions of an intelligent client service module resident on a personal computer.

18. The method for an authentication process within a distributed data processing system of claim 17, the actions of the trusted remote engine manager actions further comprising:
validating identification card information;
validating virtual security officer(s) signatures;
determining if the request being received is from an authenticated user;
based on model definition (policies and rules), determining placement of non-secure data;
keeping participant audits;
notifying other managers or service components for alternative processing such as access control, rules and policies and encryption key agreements; and
auditing all processes.

19. The method for an authentication process within a distributed data processing system of claim 17, the actions of the intelligent client service further comprising:
performing self-registration;
performing private signing key and verification;
performing authentications;
performing MAC generation for data integrity;
placing electronic signatures; and
performing data encryption/decryption.

20. The method for an authentication process within a distributed data processing system of claim 17, the actions of the virtual security officer(s) sub-module further comprising:
validating requests for registration;
generating a type of identification card;
signing the identification card; and
sending the identification card to a requesting participant by placing a copy of the identification card in one of the defined modeled locations.
